(19) United States
(12) Patent Application Publication
(10) Pub. No.: US 2004/0156403 A1
(43) Pub. Date: Aug. 12, 2004

(54) Compression-tunable fiber laser and compression-resistant optical fiber for lasers

(76) Inventor: Adrian Carter, Bulli (AU)

Correspondence Address: NUFERN, 7 AIRPORT PARK ROAD, EAST GRANBY, CT, 06026, US

(21) Appl. No.: 10/734,632

(22) Filed: Dec. 12, 2003

Related U.S. Application Data
(63) Continuation of application No. PCT/US02/18873, filed on Jun. 11, 2002.
(60) Provisional application No. 60/297,638, filed on Jun. 12, 2001.

(51) Int. Cl. H01S 3/10

(52) U.S. Cl. 372/20

(57) ABSTRACT

The present invention provides an optical fiber which inherently has sufficient mechanical strength in compression to facilitate compression tuning of a grating therein. This is achieved by manufacturing a fiber that has an unusually large diameter cladding and a substantially single mode core. The fiber includes optically active material so that the fiber can be employed in a fiber laser. The fiber is preferable photosensitive so that the grating(s) can be written into the fiber after manufacture, although other means of impressing, forming or writing the grating are envisaged and the grating(s) can be written into the fiber at the time of manufacture if desired.

### CROSS-REFERENCE TO RELATED APPLICATIONS

This application is a continuation of International Application No. PCT/US02/18873, which has an international filing date of Jun. 11, 2002, and is entitled “Compression-Tunable Fiber Laser and Compression-Resistant Optical Fiber for Lasers”, and which in turn claims priority to U.S. Provisional Patent Application Serial No. 60/297,638, which was filed Jun. 12, 2001 and is also entitled “Compression-Tunable Fiber Laser and Compression-Resistant Optical Fiber for Lasers”. The foregoing applications are incorporated herein by reference.

### TECHNICAL FIELD

The present invention relates to compression-tunable fiber lasers. The present invention also relates to a compression-resistant optical fiber suitable for use in a compression-tunable fiber laser.

### BACKGROUND

It is known to create a fiber laser by impressing a pair of gratings into a doped optical fiber to form a resonant cavity within the optical fiber. Alternatively, it is also known to form the resonant cavity with a mirror at one end of a fiber and a single grating at the other end thereof. Alternatively again, it is known to create a distributed feedback (DFB) fiber laser with a single grating. Examples of DFB lasers are described in U.S. Pat. No. 5,771,251 entitled “Optical Fibre Distributed Feedback Laser”, issued to Kringlebotn et al. and which is incorporated by reference herein to the extent required to understand the present invention.

Gratings are typically written into a photosensitive optical fiber by careful exposure of the optical fiber to UV light as is known in the art. In the case of a pair of gratings, the gratings are usually axially separated by a selected section of optical fiber which is doped with an optically active dopant such as a rare earth (eg. erbium) which, when properly excited, emits coherent light.

A tunable fiber laser having a pair of gratings axially separated by a length of doped fiber is described in U.S. Pat. No. 5,317,576, entitled “Continuously Tunable Single-Mode Rare-Earth Doped Pumped Laser Arrangement” and issued to Ball et al., and which is incorporated by reference herein to the extent necessary to understand the present invention. This fiber laser has its lasing wavelength tuned by mechanically stretching the grating(s).

U.S. Pat. No. 5,691,999, entitled “Compression-Tuned Fiber Laser”, which is also issued to Ball et al. and incorporated by reference herein to the extent necessary to understand the present invention, teaches the operation of a tunable fiber laser in compression. As would be known to a person skilled in the art, typical single-mode optical fiber has a core diameter of about 8 microns and a cladding outside diameter of about 125 microns. Thus, it is clearly incapable of resisting compression by itself. Compression is therefore achieved in the '999 patent by locating ferrules around the optical fiber and placing the ferrules in a mechanical structure to apply axial compression to the optical fiber via the ferrules. The ferrules must be manufactured to tight tolerances so as to properly fit the fiber for the transmission of axial compression forces thereto. The '999 patent notes that operating the optical fiber in compression is preferred over operating the optical fiber in tension, as tension causes microcracks which ultimately cause the optical fiber to fail and hence longevity is limited in tension. Further, another advantage of tuning a fiber laser in compression rather than tension is the fact that it allows the fiber laser to be tuned over a much wider range of wavelengths. This is particularly desirable in view of the current trend towards wavelength division multiplexing, which can benefit from a wide tuning range, most preferably over the entire Erbium C-band of 1525-1565 nm.

International Patent Application PCT/US99/28865 entitled “Tube-Encased Fiber Grating”, which is owned by CIDRA Corporation and is herein incorporated by reference to the extent necessary to understand the present invention, develops the compression-tunable fiber laser art further. This application teaches an arrangement in which a permanent capillary tube is fused over an optical fiber having either one or two gratings to provide permanent and localised physical support to the optical fiber in the region of the grating(s) such that the optical fiber, with the assistance of the fused capillary tube, can resist compressive tuning loads to thereby tune a fiber laser. Thus, the temporary ferrules required in the '999 patent are replaced with a permanent fused capillary tube. It will be appreciated that fusing the capillary tube to the optical fiber is a relatively complex and difficult operation, which has a propensity to distort the optical fiber and/or trap air bubbles.

It is an object of the present invention to advance the art of compression-tuned fiber lasers.

### SUMMARY

The present invention provides a compression tunable fiber laser having an optical fiber having a substantially single-mode core that includes an optically active element and wherein the fiber inherently has sufficient mechanical strength in compression to facilitate compression tuning of a reflective element therein. This can be achieved by manufacturing a fiber that has an unusually large diameter cladding.

The fiber is preferably photosensitive so that the reflective element can include a grating written into the fiber after manufacture via exposure to UV light, although other means of impressing, forming or writing the grating are envisaged. A grating or gratings can be written into the fiber at the time of manufacture, if desired.

In one aspect, the present invention provides a compression-tunable fiber laser including an optical fiber having a substantially single-mode core characterized by a first refractive index and a cladding layer disposed about the core, where the cladding layer is characterized by a second refractive index that is lower than the first refractive index. The optical fiber can include an optically active dopant and at least one grating providing a selected reflection at a selected wavelength, where the cladding layer has an outside diameter sufficiently large to enable the optical fiber to resist buckling under compressive loads sufficient to cause compression tuning of the selected wavelength over a range of at least 0.1 nm.

In another aspect, the present invention provides a compression-tunable laser apparatus. The compression tunable laser apparatus can include a first optical fiber having a core including an active element, a cladding disposed about the core, and a reflective element. A second optical fiber is optically coupled with the first optical fiber, and includes a substantially single-mode core characterized by a first refractive index and a cladding layer disposed about the core, where the cladding layer is characterized by a second refractive index which is lower than the first refractive index and a grating for providing a selected reflection at a selected wavelength. The cladding layer of the second optical fiber can have an outside diameter sufficiently large to enable the optical fiber to resist buckling under compressive loads sufficient to cause compression tuning of the selected wavelength over a range of at least 0.1 nm.

### DESCRIPTION OF DRAWINGS

The present invention can be more clearly understood from a consideration of the following Detailed Description and the accompanying drawings, in which:

FIG. 1 is a longitudinal sectioned view of a single-mode optical fiber including a single grating according to the prior art;

FIG. 2 is a longitudinal sectioned view of a single-mode optical fiber including a single grating according to the present invention;

FIG. 3 is a longitudinal sectioned view of a single-mode optical fiber including a pair of axially spaced gratings according to the present invention;

FIG. 4A is a longitudinal sectioned view of a laser apparatus including first and second optical fibers that are butt-coupled together;

FIG. 4B is a longitudinal sectioned view of a laser apparatus including first and second optical fibers that are spliced together; and

FIG. 4C is a longitudinally sectioned view of a laser apparatus including first and second optical fibers that are optically coupled so as to include free space transmission between the fibers.

### DETAILED DESCRIPTION

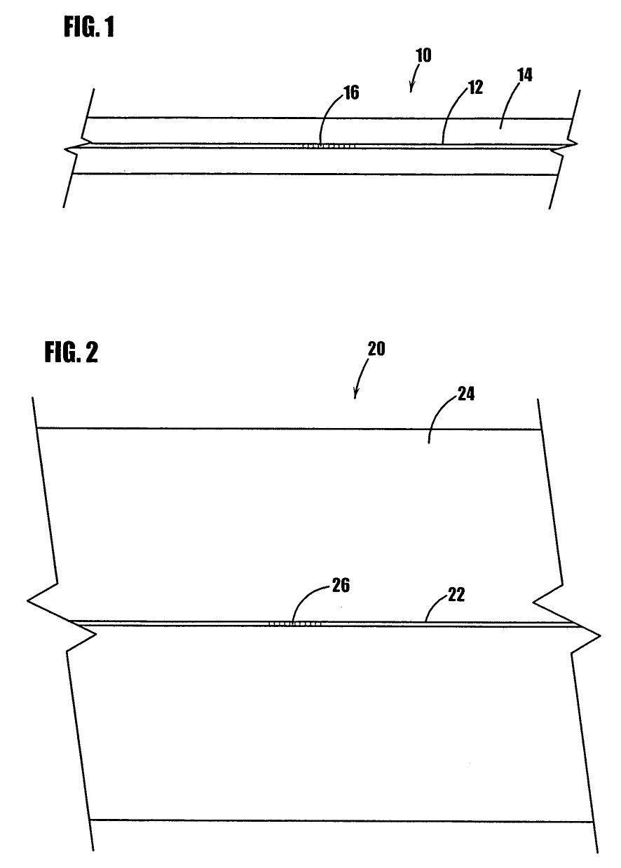

Referring firstly to FIG. 1, there is illustrated a single-mode optical fiber 10 of the prior art suitable for use in a distributed feedback (DFB) fiber laser.

As is conventional, the optical fiber 10 is comprised of a core 12 that includes an optically active dopant, a cladding 14 and a grating 16. As is known in the art, the core 12 has a refractive index that is higher than at least the radially inner region of the refractive index of the cladding 14 such that light is substantially guided through the core.

The substantially single-mode optical fiber 10 of FIG. 1 typically has a cladding 14 with an outer diameter of about 125 microns and thus some form of external reinforcement is required to operate the fiber 10 of FIG. 1 in a compression-tuned fiber laser.

FIG. 2 illustrates a single-mode optical fiber 20 according to the present invention that is suitable for use in a compression-tuned DFB fiber laser. Preferably, the diameter of the core 22 is from 4-15 microns, and more preferably, the diameter of the core 22 is about 8 microns. The core 22 includes an optically active material. However, the outer diameter of the cladding 24 is at least 1000 microns, and preferably in the range of 2000-4000 microns, although it can be greater. Thus, the ratio of diameter of the cladding diameter to core diameter has been substantially increased from a conventional ratio of about 15 illustrated in FIG. 1 to a ratio of at least about 125 illustrated in FIG. 2. This provides the mechanical strength required to resist buckling and hence enables the fiber to operate in compression without any external reinforcement such as ferrules or capillary tubes. The numerical aperture of the fiber 20 is preferably in the range from 0.3 to 0.7.

The fiber 20 includes a compression-tunable reflective element, such as the grating 26. The grating 26 can be impressed or written therein by conventional means such as, for example, exposure to UV light, in which case the fiber 20 includes photosensitive material that alters its refractive index when exposed to UV light. In other embodiments, the grating 26 may be impressed, formed or written by other means, in which case the fiber need not include photosensitive material.

The grating 26 can be similar to those described in U.S. Pat. Nos. 4,725,110 and 4,807,950, entitled “Method for Impressing Gratings Within Fiber Optics”, and issued to Glenn et al, and in U.S. Pat. No. 5,388,173, entitled “Method and Apparatus for Forming Aperiodic Gratings in Optical Fibers”, issued to Glenn. The foregoing are incorporated by reference herein to the extent necessary to understand the present invention.

Any compression-tunable reflective element that can be embedded, etched, imprinted, or otherwise formed in the fiber may be used if desired. Thus, as used herein, the term “grating” means any such reflective elements. Further, the reflective element (or grating) may be used in reflection and/or transmission of light.

The fiber 20 includes an optically active material in the core 22, such as erbium and/or ytterbium, which can be excited or pumped to emit coherent light, as is known in the art.

The core can be co-doped with the rare earths erbium and ytterbium, and can include phosphorous, which is understood to reduce back transfer from the erbium to the ytterbium, in the manner described in one or more of the following: U.S. Pat. No. 5,225,925, entitled “Sensitized Erbium Fiber Optical Amplifier and Source”, issued Jul. 6, 1993; to Grub et al.; M. L. Fermann et al., “Efficient Operation of an Yb Sensitized Er Fibre Laser at 1.56 μm”, Electronics Letters, vol. 24, no. 18, Sept. 1, 1988, at 1135-1136; and Barnes et al., “Er³⁺Yb³⁺ and Er³⁺ Doped Fiber Lasers”, Journal of Lightwave Technology, vol. 7, no. 10, October 1989, at 1461-1465. All of the foregoing are incorporated by reference herein to the extent necessary to understand the present invention.

Preferably, a fiber according to the invention does include a photosensitive material for facilitating the writing of a grating. Fibers can be rendered photosensitive by hydrogen loading, as is known in the art, as well as by the incorporation of germanium. Boron can be included for enhancing the photosensitivity of the fiber. In a preferred practice of the invention, photosensitive materials are disposed about the rare earth materials erbium and ytterbium, such as by being distributed in a ring surrounding the erbium and ytterbium. See U.S. Pat. No. 5,881,197 entitled “Optical Fibre And Optical Fibre Device”, and issued March 9, 1999 to Dong et al., and which is herein incorporated by reference to the extent necessary to understand the present invention. The term “disposed about,” as used herein, means that one material surrounds, at least partially, another material; however, the two materials need not be adjacent, and the may be a layer of a third material in between the first and second materials.

The optical fiber 20 is drawn from a preform. According to the invention, the preform, which according to the prior art has a cladding diameter to core diameter ratio of about 15, is modified so as to achieve a ratio of about 125 or greater in the preform. Specifically, additional cladding material is introduced to the preform by one or more drawing and external deposition processes that incrementally deposit the additional cladding material on the existing cladding of the preform. Alternatively, the preform can undergo one or more drawing and oversleeving processes which for depositing the cladding material on the existing cladding. For example, a preform having a core and cladding, where the cladding has a diameter of 12 mm may be uniformly drawn so as to reduce its diameter to 8 mm. A sleeve having an inner diameter of 10 mm and an outer diameter of 30 mm may then be placed over the preform and collapsed under heat onto the preform. The foregoing steps can be repeated as many times as necessary to achieve the desired ratio of core to cladding. It may be advantageous to cut the preform, such by halving the preform or cutting the preform into thirds to facilitate subsequent drawing and oversleeving. Each of the cut lengths can then be oversleeved and drawn. The core of the preform is sized such that, taking into account the material to be added, the final preform, when drawn, yields a substantially single mode core at a selected wavelength, or over a wavelength range of interest, such as, for example, C, S or L band.

The modified or “overclad” preform is ultimately drawn to produce the optical fiber 20. Preferably, the draw speed is on the order of meters per minute rather than the more conventional meters per second. In one practice of the invention, the draw speed is less than 10 meters per minute. Furthermore, it is preferable to cut reasonable lengths of the fiber as the fiber is drawn, as the fiber can be difficult or impossible to bend around a collecting spool. It is common when drawing prior art fiber to coat the fiber immediately after drawing with a protective coating, such as a polymer. In one practice of the present invention, the fiber 20 is not coated with such a protective coating.

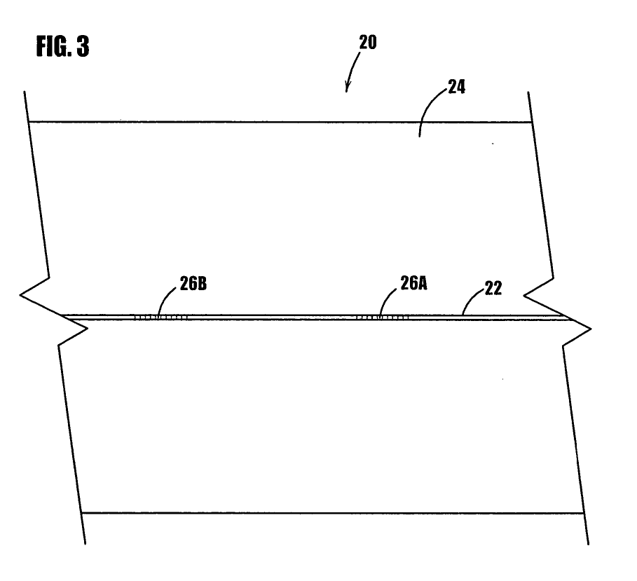

Referring now to FIG. 3, a pair of axially spaced reflective elements 26A and 26B can be included in the optical fiber 20 suitable for use in a compression-tuned fiber laser. At least one of the reflective elements 26A and 26B is compression tunable, and is preferably a Bragg grating formed via exposure of a selected portion of the fiber 20 to UV radiation. The other reflective element can be other than a grating, such as, for example, a mirror. The reflective elements 26A and 26B can both be gratings and can have the same reflection wavelengths and/or profiles. The reflective elements 26A and 26B form an optical cavity and the fiber 20, at least between the gratings 16 (and optionally in the region of the gratings themselves, and/or the fiber outside the gratings), is doped with an optically active material such as a rare earth (e.g. erbium and/or ytterbium, etc.).

In use, the optical fiber of the present invention as shown FIGS. 2 and 3 receives pump light for pumping the optically active material in the core 22. Compression tuning can be achieved by suitably clamping the optical fiber 20 and applying an axial compressive load to the fiber 20. The magnitude of the compressive load which must be resisted by the fiber is dictated by the magnitude of the bandwidth over which tuning is required. If a small bandwidth or tunability is desired (e.g., less than 1 nm) then the optical fiber need only be able to resist modest compressive loads. However, if it is desired to tune the fiber laser over, say, 20 nm or more, then the optical fiber 20 needs to be able to resist greater compressive loads.

According to one approximation understood to those of ordinary skill in the art to be useful, the wavelength of a fiber Bragg grating is tuned as a function of strain according to the formula:

Δλ=0.78 ×λ×ε

where Δλ, is the change in the operating wavelength λ is an operating wavelength that is tuned of the filter and ε is the applied strain. See S. Y. Set et al., “A Widely Tunable Fiber Bragg Grating With A Wavelength Tunability Over 40 nm”, OFC 2001 Technical Digest Series—Monday Mar. 19, 2001, Paper MC-4.

For example, according to the formula, 0.1% strain yields a Δλ of 1.15 nm at an operating wavelength of 1480 nm. The Young's modulus of glass, which relates stress to strain, is typically about 10.7 Mpsi.

A tunable fiber laser according to the invention can be useful in a Dense Wavelength Division Multiplexed (DWDM) communications system. In a DWDM communication system, multiple wavelengths of light are transmitted over an optical fiber, and each wavelength is a separate communications channel. The channels are typically spaced by 100 GHz or less, which corresponds to approximately 0.8 nm spacing in terms of wavelength in the C-band range of wavelengths (approximately 1530-1565 nm). Channels can be spaced by 50 GHz, corresponding to 0.4 nm, and 25 GHz, corresponding to 0.2 nm. Channel spacings of 12.5 GHz, or approximately 0.1 nm, are even more advantageous, as spacing the channels more closely allows more channels, and hence more information, to be transmitted over the C-band range of wavelengths. The C-band range of wavelengths is of current interest due to the ready availability of erbium-doped fiber amplifiers (EDFA's) for amplifying signals in the C-band.

Each channel in a DWDM system requires a laser source, which is modulated to transmit information over the channel. It is prudent to provide a spare laser source for each channel to provide laser light should the primary laser source fail. Typically, laser light sources are fixed, that is, operate at an essentially fixed wavelength. Thus DWDM can be very expensive in that it requires a large number of different spare laser sources. Accordingly, a tunable laser light source can allow fewer spares to maintained and allow a single laser design, or fewer designs, to be provided.

As understood by one of ordinary skill in the art, in light of the disclosure herein, the slenderness ratio, or the ratio of the width of a column to the length of the column, is an important factor in determining when a column, such as a fiber, buckles. For a given outside diameter of the cladding, shorter pieces of fiber can withstand higher loads without buckling. Accordingly, the thickness of the cladding sufficient to prevent buckling under a compressive stress can vary with the length of the fiber. A shorter length of fiber can have a thinner cladding.

It is applicant's understanding that prior art single mode fibers essentially cannot withstand compressive loads sufficient to tune a Bragg grating over any useful bandwidth whatsoever, let alone tune a Bragg grating from one channel to the next, such as for example, 0.1 nm.

The present invention provides an optical fiber that is suitable for use in a compression-tuned fiber laser without external reinforcement or support other than appropriate fixturing to apply compressive force to the fiber. It thus eliminates the requirements of the prior art for reinforcement, either in the form of a removable ferrule, or in the form of a permanently fused capillary tube.

Thus in one practice of the invention, there is provided an optical fiber wherein the cladding layer has an outside diameter sufficiently large to enable the optical fiber to resist buckling under compressive loads sufficient to cause compression tuning of a selected wavelength over a range of at least 0.1 nm. More preferably, the cladding has an outside diameter sufficient to enable the optical fiber to resist buckling under compressive loads sufficient to cause compressive tuning of a selected wavelength over a range of at least 1 nm. Most preferably, the foregoing range is at least 5 nm.

In another practice of the invention, there is provided an optical fiber having a cladding layer of an outside diameter sufficiently large to enable the optical fiber to resist buckling under a compressive stress sufficient to provide a strain of at least 0.1% for a length of the fiber of at least one (1) centimeter.

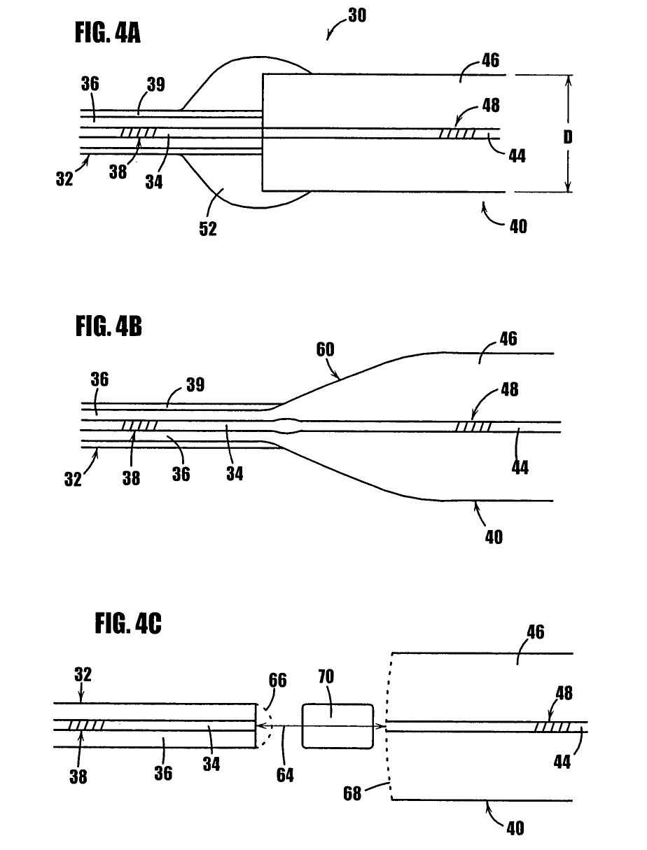

FIG. 4A illustrates another embodiment of the invention. Shown in FIG. 4A is a tunable fiber laser apparatus 30 that includes two optical fibers that are optically coupled for the transmission of light therebetween.

The optical fiber 32 includes a core 34 including an active element, a cladding 36 disposed about the core 34, and a reflective element 38, which in FIG. 4A is preferably a cleaved end of the of the fiber and/or a mirror. The first optical fiber 32 can be a rare-earth doped optical fiber having an outer diameter of the cladding 36 of approximately 125 um. The fiber 32 can also include a protective coating 39, which can be partially stripped if desired prior to butt coupling the first fiber 32 to the second fiber 40.

The second optical fiber 40 includes a substantially single-mode core 44 characterized by a first refractive index; a cladding layer 46 disposed about the core 44, where the cladding layer 46 is characterized by a second refractive index which is lower than the first refractive index, and a compression tunable reflective element 48, which in FIGS. 4A-4C is a grating. As described above, the cladding of the second fiber has an outside diameter D sufficiently large to enable the optical fiber to resist buckling under compressive loads for tuning the grating 48. For example, the cladding 46 can have a diameter D sufficient to allow compression tuning of the grating over a range of at least 0.1 nm, where the wavelength being tuned is, for example, in the visible range or longer, and preferably is in the range of C, S, or L band. Alternatively or additionally, the diameter D of the cladding 46 is at least about 125 times the outside diameter of the substantially single mode core 44. One of the reflective elements 38 and 48 is partially reflective for allowing laser light to escape the resonant cavity formed between the two reflective elements 38 and 48.

The first and second fibers 32 and 40 are shown as butt coupled in FIG. 4A for providing optical coupling therebetween, and a suitable “glue” 52, such as an appropriate optical epoxy, can secure the first optical fiber 32 and the second fiber 40 together.

Alternatively, the first and second optical fibers can fusion spliced, as shown in FIG. 4B. It may be advantageous to strip an appropriate length of the protective coating 39 from the first optical fiber 32 for prior to fusion splicing. The spliced area can then be recoated with a protective coating. The outside diameter of the second optical fiber 40 can be tapered, as indicated by reference numeral 60, by grinding or other appropriate forming, such as drawing (when drawing, care should be taken ensure that diameter of the core 44 is not reduced so as produce unacceptable loss or reflections) prior to fusion splicing the two fibers 32 and 40 together. The process of fusion splicing the two fibers 32 and 40 can also taper the second optical fiber 40.

As shown in FIG. 4C, optical coupling between the first and second fibers can include the free space transmission of light between the first and second fibers, as indicated by reference numeral 64. One or both of the fibers can include lens elements formed on the ends thereof, as indicated by reference numerals 66 and 68, respectively, and an optical element 70, such as, for example, a grin lens, can also be included for improving the transmission of light between the first and second optical fibers 32 and 40.

As noted above, and discussed in the aforementioned '197 patent issued to Dong et al., certain desirable rare earth dopants, such as ytterbium and erbium, can be somewhat troublesome, though not impossible, to incorporate in the same fiber with certain photosensitive materials desirable for forming gratings. Accordingly, the embodiments shown illustratively in FIGS. 4A-4C can advantageously allow active material and photosensitive material to be in different fibers. The fiber including the active material can include a reflective element such as, for example, a mirror or cleaved end of the fiber, that does not require significant, if any, photosensitive material to be formed in the fiber. The other fiber including the photosensitive material can be suitable for compression tuning a grating formed in the fiber.

It will of course be realised that the foregoing detailed description of the preferred embodiments has been given by way of illustrative examples, and not of limitation, of the present this invention. As a disclosure is not properly an encyclopaedic dissertation, one of ordinary skill in the art, in light of the disclosure above, can make certain modifications and/or substitutions within the spirit of the invention and scope of the claims.

Having described the invention, what is claimed as new and to be secured by Letters Patent is:

1. A compression-tunable laser apparatus, comprising:
a first optical fiber having a core including an active material, a cladding disposed about said core, and a reflective element;
a second optical fiber, optically coupled with said first optical fiber, said second optical fiber including
a substantially single-mode core characterized by a first refractive index;
a cladding layer disposed about said core, said cladding layer characterized by a second refractive index which is lower than said first refractive index;
a grating providing a selected reflection at a selected wavelength; and wherein said cladding layer of said second fiber has an outside diameter sufficiently large to enable the optical fiber to resist buckling under compressive loads sufficient to cause compression tuning of said selected wavelength over a range of at least 0.1 nm.

2. The compression-tunable laser apparatus of claim 1 wherein said optical coupling of said first and second fibers includes free space transmission of light between said first and second fibers

3. The compression-tunable laser apparatus of claim 1 wherein said first and second optical fibers are one of fusion spliced and butt-coupled.

4. A compression-tunable laser apparatus, comprising:
a first optical fiber having a core including an active element, a cladding disposed about said core, and a reflective element;
a second optical fiber, optically coupled with said first optical fiber, said second optical fiber including
a substantially single-mode core characterized by a first refractive index;
a cladding layer disposed about said core, said cladding layer characterized by a second refractive index which is lower than said first refractive index, said cladding layer of said second fiber having an outside diameter which is at least about 125 times the outside diameter of said substantially single mode core; and
a grating;
whereby compression of second fiber can tune said grating for tuning the wavelength of laser light produced by said laser apparatus.

5. The compression-tunable laser apparatus of claim 4 wherein said optical coupling of said first and second fibers includes free space transmission of light between said first and second fibers

6. The compression-tunable laser apparatus of claim 4 wherein said first and second optical fibers are one of fusion spliced and butt-coupled.

7. A method of fabricating an optical fiber, comprising:
forming a preform having a cladding disposed about a core material;
drawing the preform to reduce the diameter thereof;
adding more cladding to the cladding of the preform;
drawing the preform to reduce the diameter thereof;
adding additional cladding to the cladding of the preform;
again drawing the preform to reduce the diameter thereof; and
drawing the preform to provide an optical fiber having a substantially single-mode core and a cladding having a diameter that is at least 125 times the diameter of the core; and
wherein the foregoing are performed in the order recited.
